(19) United States
(12) Patent Application Publication
(10) Pub. No.: US 2025/0060161 A1
(43) Pub. Date: Feb. 20, 2025

(54) Bathroom Drying System

(71) Applicant: La Fan, LLC, Aiken, SC (US)

(72) Inventor: James Leonard, Aiken, SC (US)

(73) Assignee: La Fan, LLC, Aiken, SC (US)

(21) Appl. No.: 18/233,883

(22) Filed: Aug. 15, 2023

(51) Int. Cl. F26B 21/00; E03D 9/04; F26B 3/04; F26B 21/10

(52) U.S. Cl. CPC F26B 21/004; E03D 9/04; F26B 3/04; F26B 21/10

(57) ABSTRACT

A bathroom drying system, including a ceiling fan, including an outer cover to removably connect to at least a portion of a ceiling, a plurality of fan blades movably disposed within at least a portion of the outer cover to blow air and dry at least one of a shower and a bathtub, and a light connected to at least a portion of the outer cover to illuminate and emit at least one beam of light therefrom, a fan control device connected to the ceiling fan to control at least one operation of the plurality of fan blades, and a light control device connected to the light to control at least one operation of the light.

### BACKGROUND

### 1. Field

The present general inventive concept relates generally to a bathroom, and particularly, to a bathroom drying system.

### 2. Description of the Related Art

While using a shower and/or a bathtub, a bathroom will often become foggy due to steam created from water used. The bathroom will become a moist and humid environment, which can encourage growth of mold and/or mildew.

Many people will expend considerable effort to cleanse and/or remove the mold. Moreover, some of the cleaning agents used can be pose a health risk to the person doing the cleaning. Unfortunately, the repeated occurrence of the moist and humid environment will cause more mold to grow.

Therefore, there is a need for a bathroom drying system to blow air into the shower and/or the bathtub to prevent growth of mold.

### SUMMARY

The present general inventive concept provides a bathroom drying system.

Additional features and utilities of the present general inventive concept will be set forth in part in the description which follows and, in part, will be obvious from the description, or may be learned by practice of the general inventive concept.

The foregoing and/or other features and utilities of the present general inventive concept may be achieved by providing a bathroom drying system, including a ceiling fan, including an outer cover to removably connect to at least a portion of a ceiling, a plurality of fan blades movably disposed within at least a portion of the outer cover to blow air and dry at least one of a shower and a bathtub, and a light connected to at least a portion of the outer cover to illuminate and emit at least one beam of light therefrom, a fan control device connected to the ceiling fan to control at least one operation of the plurality of fan blades, and a light control device connected to the light to control at least one operation of the light.

The outer cover may include a main body, a plurality of vent apertures circumferentially disposed on at least a portion of the main body on a cylindrical surface of the main body to facilitate movement of air therethrough, and a central aperture disposed at a center of the main body.

The plurality of fan blades may be disposed within the central aperture.

The bathroom drying system may further include a heating control unit disposed within at least a portion of the outer cover to generate heat and increase a temperature level of the air blown from the plurality of fan blades.

The fan control device and the light control device may be integrated as a software application on a computing device.

The bathroom drying system may further include a computing device running a program thereon to automatically create a drying cycle on a bathroom based on a size of a room, a temperature level of the room, and a humidity level of the room.

### BRIEF DESCRIPTION OF THE DRAWINGS

These and/or other features and utilities of the present generally inventive concept will become apparent and more readily appreciated from the following description of the embodiments, taken in conjunction with the accompanying drawings of which:

FIG. 1 illustrates a side perspective view of a bathroom drying system, according to an exemplary embodiment of the present general inventive concept;

FIG. 2 illustrates an exploded view of the bathroom drying system, according to an exemplary embodiment of the present general inventive concept;

FIG. 3 illustrates a zoomed in view of a fan control device, according to an exemplary embodiment of the present general inventive concept; and

FIG. 4 illustrates a zoomed in view of a light control device, according to an exemplary embodiment of the present general inventive concept.

### DETAILED DESCRIPTION

Various example embodiments (a.k.a., exemplary embodiments) will now be described more fully with reference to the accompanying drawings in which some example embodiments are illustrated. In the figures, the thicknesses of lines, layers and/or regions may be exaggerated for clarity.

Accordingly, while example embodiments are capable of various modifications and alternative forms, embodiments thereof are shown by way of example in the figures and will herein be described in detail. It should be understood, however, that there is no intent to limit example embodiments to the particular forms disclosed, but on the contrary, example embodiments are to cover all modifications, equivalents, and alternatives falling within the scope of the disclosure. Like numbers refer to like/similar elements throughout the detailed description.

It is understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art. However, should the present disclosure give a specific meaning to a term deviating from a meaning commonly understood by one of ordinary skill, this meaning is to be taken into account in the specific context this definition is given herein.

### LIST OF COMPONENTS

Bathroom Drying System 1
Ceiling Fan 100
Outer Cover 110
Main Body 111
Vent Apertures 112
Central Aperture 113
Blades 120
Light 130
Heating Control Unit 140
Power Source 150
Blade Cover 160
Surface Connector 170
Fan Control Device 200
Controller Body 210
Power Button 220
Direction Button 230
Oscillator Button 240
Heat Button 250
Speed Buttons 260
First Speed Button 261
Second Speed Button 262
Third Speed Button 263
Light Control Device 300
Control Body 310
Power Switch 320
Illumination Level Switch 330
Flashing Switch 340

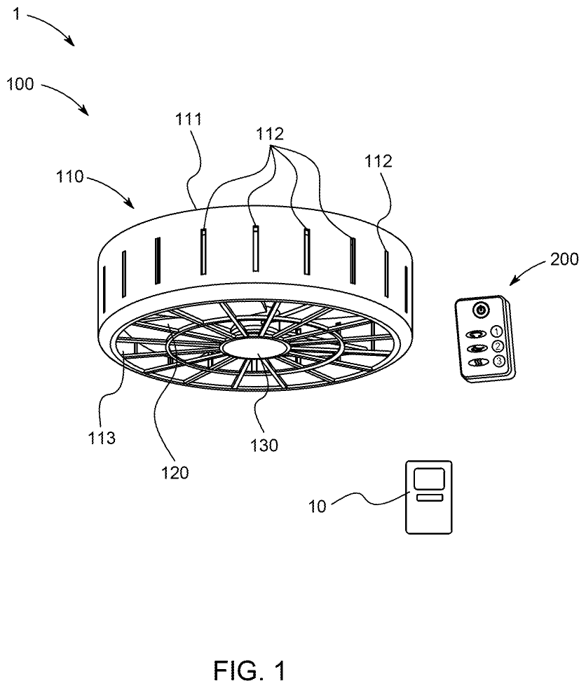

FIG. 1 illustrates a side perspective view of a bathroom drying system 1, according to an exemplary embodiment of the present general inventive concept.

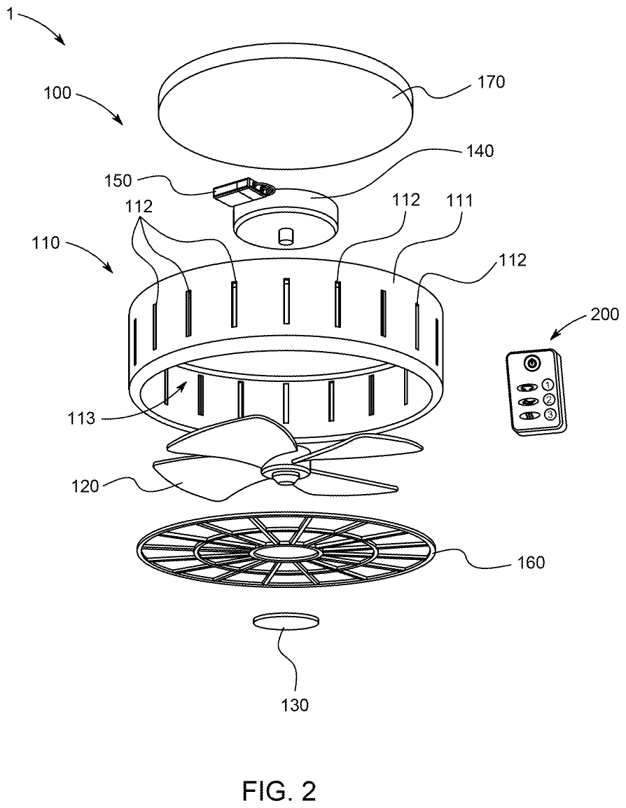

FIG. 2 illustrates an exploded view of the bathroom drying system 1, according to an exemplary embodiment of the present general inventive concept.

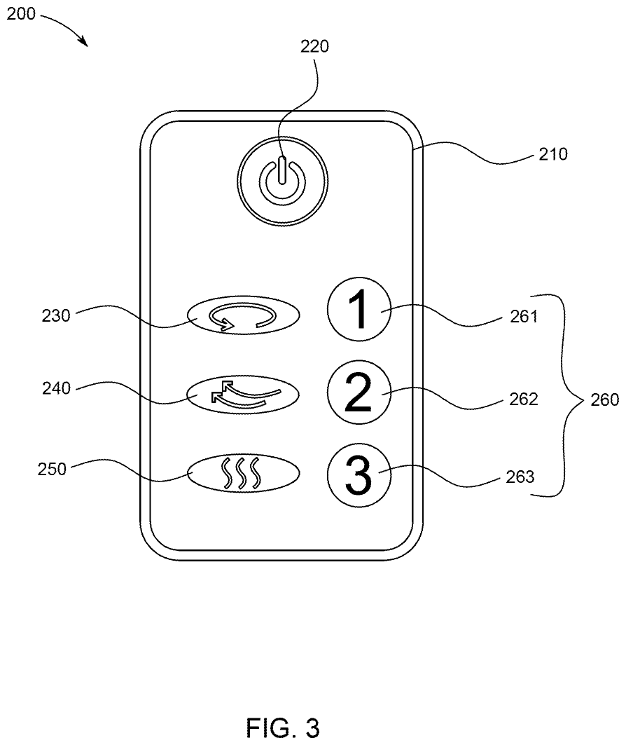

FIG. 3 illustrates a zoomed in view of a fan control device 200, according to an exemplary embodiment of the present general inventive concept.

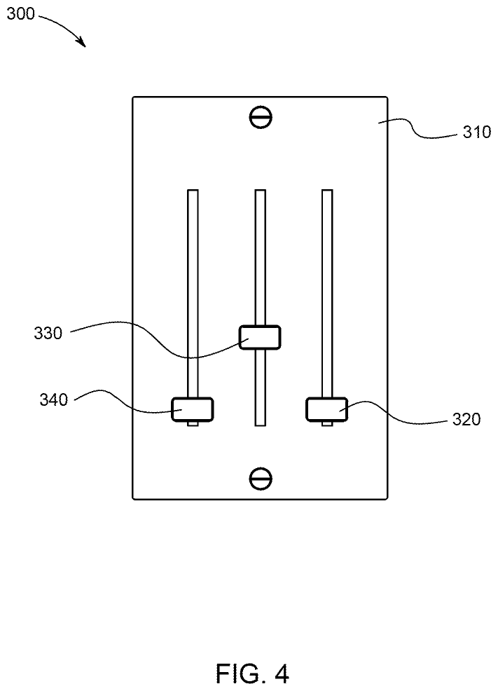

FIG. 4 illustrates a zoomed in view of a light control device 300, according to an exemplary embodiment of the present general inventive concept.

Referring to FIGS. 1 through 4, the bathroom drying system 1 may include a ceiling fan 100, a fan control device 200, and a light control device 300, but is not limited thereto.

The ceiling fan 100 may be constructed from at least one of metal, plastic, wood, and rubber, etc., but is not limited thereto.

The ceiling fan 100 may include an outer cover 110, a plurality of blades 120, a light 130, a heating control unit 140, a power source 150, a blade cover 160, and a surface connector 170, but is not limited thereto.

Referring to FIGS. 1 and 2, the outer cover 110 is illustrated to have a cylindrical shape. However, the outer cover 110 may be rectangular, triangular, pentagonal, hexagonal, heptagonal, octagonal, or any other shape known to one of ordinary skill in the art, but is not limited thereto.

The outer cover 110 may include a main body 111, a plurality of vent apertures 112, and a central aperture 113, but is not limited thereto.

The main body 111 may be removably connected to at least a portion of an external surface, such as a ceiling, a wall, a table, a desk, and/or any other planar surface.

The plurality of vent apertures 112 may be circumferentially disposed on at least a portion of the main body 111, such that the plurality of vent apertures 112 are disposed on a cylindrical surface of the main body 111. Also, each of the plurality of vent apertures 112 may be distanced from each other. The plurality of vent apertures 112 may facilitate movement of air therethrough.

The central aperture 113 may be disposed at a center of the main body 111. The central aperture 113 may facilitate movement of the air therethrough.

The plurality of fan blades 120 may be movably (i.e., rotatably) disposed within at least a portion of the central aperture 113. The plurality of fan blades 120 may blow the air away therefrom in response to moving (i.e., rotating) in a first rotational direction (i.e., clockwise) or a second rotational direction (i.e., counterclockwise) using a first setting. Moreover, the plurality of fan blades 120 may blow the air away from the main body 111 in response to rotating in the first rotational direction or the second rotational direction. Conversely, the plurality of fan blades 120 may blow the air into the main body 111 to circulate within the main body 111 and out of the plurality of vent apertures 112 in response to rotating in the second rotational direction or the first rotational direction using a second setting different from the first setting. In other words, the plurality of fan blades 120 may circulate the air in response to rotating in an opposite direction based on which rotational direction causes the air to move away from the main body 111. As such, the plurality of fan blades 120 may dry a shower, a bathtub, and/or a bathroom by circulating air within the shower, the bathtub, and/or the bathroom.

The light 130 may include a light-emitting diode (LED), an incandescent bulb, a fluorescent bulb, a xenon bulb, and a halogen lamp, but is not limited thereto.

The light 130 may be connected to at least a portion of the main body 111. The light 130 may illuminate and emit at least one beam of light therefrom in response to being turn on. Conversely, the light 130 may cease illuminating in response to being turned off.

The heating control unit 140 may include a motor, a heating coil, an induction heater, a processing unit (e.g., a microprocessor, a microcontroller, a processor, etc.), a communication unit (e.g., a Wi-Fi device, a radio frequency transmitter, a cellular transmitter, Bluetooth, Firewire, etc.), and a storage unit (e.g., a random-access memory (RAM), a hard drive, a solid-state drive (SSD), a flash drive, a cloud storage drive, etc.), but is not limited thereto.

The heating control unit 140 may be disposed within at least a portion of the main body 111 and/or connected to the plurality of fan blades 120 and/or the light 130. The heating control unit 140 may move (i.e., rotate) the plurality of fan blades 120 in response to movement (i.e., rotation) of the motor. Additionally, the heating control unit 140 may generate heat (i.e., increase a temperature level) therein, such that that the plurality of fan blades 120 may blow the air as hot air.

The power source 150 may include a battery, a power inlet (e.g., a power cord and plug), and a solar cell, but is not limited thereto.

The power source 150 may be disposed on and/or within at least a portion of the main body 111. The power source 150 may provide power to the plurality of fan blades 120, the light 130, and/or the heating control unit 140.

The blade cover 160 may be removably connected to at least a portion of the central aperture 113. More specifically, the blade cover 160 may cover and/or enclose the plurality of blades 120 within the central aperture 113.

The surface connector 170 may include a screw, a bolt, a nail, a washer, a nut, a cord, an adhesive (e.g., tape, glue), a magnet, and/or any combination thereof, but is not limited thereto.

The surface connector 170 may be removably connected to at least a portion of the main body 111. Additionally, the surface connector 170 may connect the main body 111 to the external surface.

The fan control device 200 may include a controller body 210, a power button 220, a direction button 230, a oscillator button 240, a heat button 250, and a plurality of speed buttons 260, but is not limited thereto.

The controller body 210 may be a portable and/or handheld device. As such, the controller body 210 may be easily stored during non-use.

The power button 220 may be disposed on at least a portion of the controller body 210. The power button 220 may turn on the plurality of fan blades 120 in response to being depressed a first time. Conversely, the power button 220 may turn off the plurality of fan blades 120 in response to being depressed a second time.

The direction button 230 may be disposed on at least a portion of the controller body 210. The plurality of fan blades 120 may move (i.e., rotate) in the first rotational direction or the second rotational direction in response to depressing the direction button 230 a first time. Conversely, the plurality of fan blades 120 may move in the second rotational direction or the first rotational direction in response to depressing the direction button 230 a second time.

The oscillator button 240 may be disposed on at least a portion of the controller body 210. The plurality of fan blades 120 may move (i.e., rotate) in the first rotational direction or the second rotational direction for a first predetermined period of time (e.g., two minutes, five minutes), and then move in the second rotational directon or the first rotational direction for a second predetermined period of time (e.g., two minutes, five minutes).

The heat button 250 may be disposed on at least a portion of the controller body 210. The heating control unit 140 may generate heat in response to depressing the heat button 250 a first time. Subsequently, the heating control unit 140 may cease generating heat in response to depressing the heat button 250 a second time.

The plurality of speed buttons 260 may include a first speed button 261, a second speed button 262, and a third speed button 263, but is not limited thereto.

The first speed button 261, the second speed button 262, and/or the third speed button 263 may be disposed on at least a portion of the controller body 210. The plurality of fan blades 120 may move (i.e., rotate) a first speed level (e.g., low) in response to depressing the first speed button 261. The plurality of fan blades 120 may move a second speed level (e.g., medium) in response to depressing the second speed button 262. The plurality of fan blades 120 may move a third speed level (e.g., high) in response to depressing the third speed button 263. Accordingly, the second speed level is greater (i.e., faster) than the first speed level and the third speed level is greater (i.e., faster) than the second speed level.

The light control device 300 may include a control body 310, a power switch 320, an illumination level switch 330, and a flashing switch 340, but is not limited thereto.

The control body 310 may be a portable and/or handheld device. As such, the control body 310 may be easily stored during non-use.

The power switch 320 may be disposed on at least a portion of the control body 310. The power switch 320 may turn on the light 130 in response to being depressed a first time. Conversely, the power switch 320 may turn off the light 130 in response to being depressed a second time.

The illumination level switch 330 may be disposed on at least a portion of the control body 310. The illumination level switch 330 may be used to adjust an illumination level of the light 130. More specifically, the light 130 may illuminate a first illumination level (e.g., low) in response to moving the illumination level switch 330 to a first end thereof. Additionally, the light 130 may illuminate at least one second illumination level in response to moving the illumination level switch 330 at least partially toward a second end thereof. It is important to note that the second end of the illumination level switch 330 may cause the light 130 to illuminate at a maximum illumination level (i.e., brightest).

The flashing switch 340 may be disposed on at least a portion of the control body 310. The light 130 may flash and/or blink in response to moving the flashing switch 340 to a first end thereof. Conversely, the light 130 may cease flashing and/or blinking in response to moving the flashing switch 340 to a second end opposite with respect to the first end.

Alternatively, the fan control device 200 and/or the light control device 300 may be implemented as a software application (i.e., an app) on a computing device 10 (e.g., a cell phone, a desktop computer, a laptop computer, a tablet computer, etc.). In other words, the computing device 10 may be used in lieu of the fan control device 200 and/or the light control device 300 to perform all of the aforementioned functions regarding the fan control device 200 and/or the light control device 300 by connecting to the processing unit and/or the communication unit of the heating control unit 140.

Also, the app on the computing device 10 may be programmed to automatically create a drying cycle using the plurality of blades 120 based on receiving input for a size of a room (e.g., the bathroom), a temperature level of the room, and/or a humidity level of the room. In other words, the computing device 10 running the app may determine a predetermined running time for the plurality of blades 120 to dry the shower, the bathtub, and/or the bathroom.

Therefore, the bathroom drying system 1 may dry the shower and/or the bathtub and prevent growth of mold. Also, the bathroom drying system 1 may reduce a necessity of using chemicals to clean the bathroom so frequently.

The present general inventive concept may include a bathroom drying system 1, including a ceiling fan 100, including an outer cover 110 to removably connect to at least a portion of a ceiling, a plurality of fan blades 120 movably disposed within at least a portion of the outer cover 110 to blow air and dry at least one of a shower and a bathtub, and a light 130 connected to at least a portion of the outer cover 110 to illuminate and emit at least one beam of light therefrom, a fan control device 200 connected to the ceiling fan 100 to control at least one operation of the plurality of fan blades 120, and a light control device 300 connected to the light 130 to control at least one operation of the light 130.

The outer cover 110 may include a main body 111, a plurality of vent apertures 112 circumferentially disposed on at least a portion of the main body 111 on a cylindrical surface of the main body 111 to facilitate movement of air therethrough, and a central aperture 113 disposed at a center of the main body 111.

The plurality of fan blades 120 may be disposed within the central aperture 113.

The bathroom drying system 1 may further include a heating control unit 140 disposed within at least a portion of the outer cover 110 to generate heat and increase a temperature level of the air blown from the plurality of fan blades 120.

The fan control device 200 and the light control device 300 may be integrated as a software application on a computing device 10.

The bathroom drying system 1 may further include a computing device 10 running a program thereon to automatically create a drying cycle on a bathroom based on a size of a room, a temperature level of the room, and a humidity level of the room.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. A bathroom drying system, comprising:
a ceiling fan, comprising:
an outer cover to removably connect to at least a portion of a ceiling,
a plurality of fan blades movably disposed within at least a portion of the outer cover to blow air and dry at least one of a shower and a bathtub, and
a light connected to at least a portion of the outer cover to illuminate and emit at least one beam of light therefrom;
a fan control device connected to the ceiling fan to control at least one operation of the plurality of fan blades; and
a light control device connected to the light to control at least one operation of the light.

2. The bathroom drying system of claim 1, wherein the outer cover comprises:
a main body;
a plurality of vent apertures circumferentially disposed on at least a portion of the main body on a cylindrical surface of the main body to facilitate movement of air therethrough; and
a central aperture disposed at a center of the main body.

3. The bathroom drying system of claim 2, wherein the plurality of fan blades are disposed within the central aperture.

4. The bathroom drying system of claim 1, further comprising:
a heating control unit disposed within at least a portion of the outer cover to generate heat and increase a temperature level of the air blown from the plurality of fan blades.

5. The bathroom drying system of claim 1, wherein the fan control device and the light control device are integrated as a software application on a computing device.

6. The bathroom drying system of claim 1, further comprising:
a computing device running a program thereon to automatically create a drying cycle on a bathroom based on a size of a room, a temperature level of the room, and a humidity level of the room.
